(19) United States
(12) Patent Application Publication
(10) Pub. No.: US 2010/0108449 A1
(43) Pub. Date: May 6, 2010

(54) PANIC BREAK

(76) Inventor: Michael Anguelo, (US)

Correspondence Address: Michaelanguelo-International Co., 733 Curtis Pkwy, Apt 1B, Miami Springs, FL, 33166, US

(21) Appl. No.: 12/246,708

(22) Filed: Nov. 4, 2008

(51) Int. Cl. B60L 7/26

(52) U.S. Cl. 188/163

(57) ABSTRACT

The present invention is a live saving devise to quickly assist those involved in an imminent accident and panic to respond to apply the vehicle's brake pedal. This devise with the push of the button #2 applying a positive current #1A to activated the solenoid #5, for a quick action to stop the vehicle. This action function as follow:

When Push-Pull switch #2, is push down, it electrically activate solenoid #5. A magnetic force is produced retracting piston and pull rod #9, at the same time brackets #6A and #6B, pull down the existing brake pedal #3, as result of these actions the existing brake pump #4 is push producing a hydraulic pressure to be transmitted to each wheel's brake cylinders expanding the brake fiber bands again the wheel's wall of the steel wheel's drum, or in a disk-brake system, getting the vehicle to stop, and stop stay until the push-pull switch is pulled up, releasing the magnetic action of the solenoid #5 making the vehicle's wheel free.

### BACKGROUND OF THE INVENTION

The present invention relates to sudden stop of a vehicle and more particularly the stopping of an automobile in a quick manner in an imminent accident.

Several designs for emergency breaks have been designed in the past. None of them, however, include an electric solenoid that force the break pedal be push down in case of an imminent accident and stay pleasured until is released.

### SUMMARY OF THE INVENTION

The Panic Break, is a devise that could be installed to any regular automobile vehicle, with the purpose of save lives in case of an imminent accident.

Precious lives are lost every year because the driver impossibleness to apply the break on time.

The Panic Break make a quick stop of the vehicle and stay as that, even if the driver lose conscious.

### BRIEF DESCRIPTION OF THE DRAWINGS

FIG. 1 Cross cut illustration of The Panic Break embodiment.

### DETAILED DESCRIPTION OF THE PREFERRED EMBODIMENT

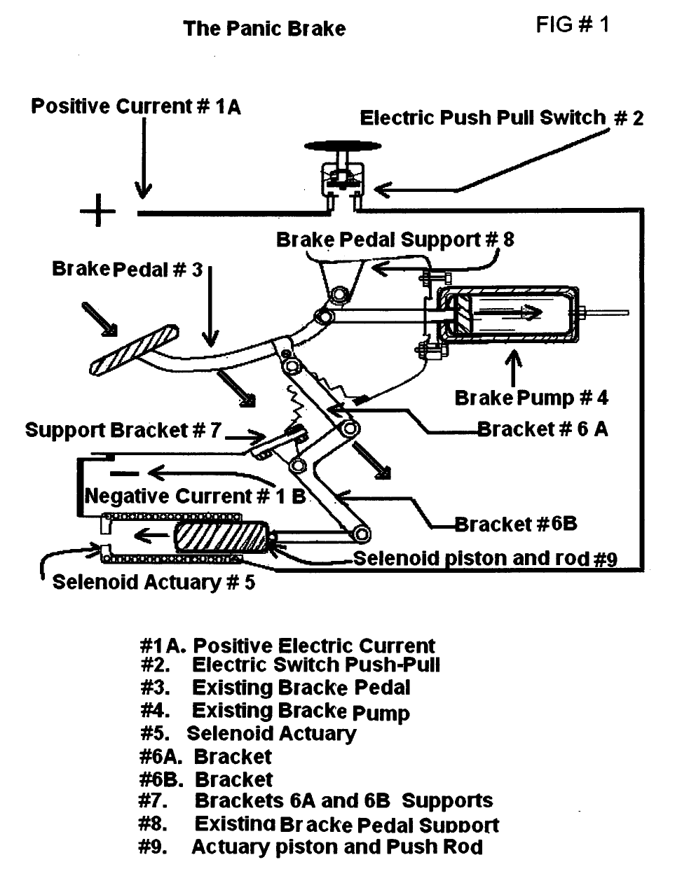

The following description of the present invention refers to FIG. 1.

The present invention includes #1. A positive 12 volts DC electric current conductor #2 an electric push-pull switch #3 a break pedal #4. A break pump #5. An electric solenoid actuary #6 Brackets #7. Support bracket #8. Break pedal support #9. Clamp.

When push pull switch is pressed a connection with actuary #5 grounded to a negative connection occurs, causing the electric solenoid be activated and the magnetic force that occurred retracts the steel piston inside the actuary, pulling bracket #6 and the bracket #6B, connected to the break pedal by clamp #9. Causing that pedal #3 be pushed down with great force creating a pressure, the pressure is transmitted to the pump #4 causing a hydraulic oil pressure to be transmitted to the four wheels break components it will expand and the vehicle stop and stay stop.

FIG. 1.
1. DC 12 volts Positive connector
2. Push pull switch
3. Break pedal
4. Break pump
5. Solenoid actuary, piston #5B
6. Bracket
6B. Bracket
7. Support bracket
8. Break pedal support
9. Brackets #6,#6B clamp

What is claimed is:

1. A device that stop a vehicle in case of an imminent accident and driver is in a panic situation or losing control of said vehicle, comprising:
A) A vehicle, a push-pull switch #2. A Brake pedal #3, bracket assembly #6A and #6B, support bracket #7, brake pump #4 and solenoid #5
B) A supports #7 and a retracting actuary- solenoid #-5
C) At least two #6A, 6B brackets attached the break pedal #-3
D) At least one support Bracket #7 bolted to the vehicle floor vertical to the break pedal
E) Panic Brake means an assembly of brackets and solenoid that through the action of the solenoid and brackets pulling down, with great force, the brake pedal resulting in a pushing force to the break pump causing that the hydraulic pressure apply pressure to the wheel's brakes system, as a result of those action the vehicle stop suddenly and stay still until switch #2 is pull back in the up position.

2. The device set forth in claim 1 wherein said Panic Break means includes a push-pull switch for activating though electricity mean activate an actuary-solenoid to apply hydraulic pressure to the wheel's break, though a pump and tubes.

3. The device set forth in claim 2 wherein said push-pull switch includes electric connection only a positive to be the contact between the positive current and the solenoid connection that when push down make that said connection, stay in contact until it is pull up to disconnect the power to the said solenoid.

4. The device set forth in claim 3 wherein said solenoid, retract the brackets # assembly causing that the attached assembly pull down with force the vehicle's break pedal #3 vehicle's break pedal#3 causing the sudden stop of said vehicle.
